(19) United States
(12) Patent Application Publication
(10) Pub. No.: US 2026/0195255 A1
(43) Pub. Date: Jul. 9, 2026

(54) STORAGE DEVICE

(71) Applicant: Samsung Electronics Co., Ltd., Suwon-si (KR)

(72) Inventors: Hyungjin Kim, Suwon-si (KR); Seokin Hong, Suwon-si (KR)

(73) Assignee: Research & Business Foundation Sungkyunkwan University, Suwon-si (KR)

(21) Appl. No.: 19/371,794

(22) Filed: Oct. 28, 2025

(30) Foreign Application Priority Data
Jan. 8, 2025 (KR) 10-2025-0003091
Mar. 31, 2025 (KR) 10-2025-0041631

(51) Int. Cl. G06F 12/02

(52) U.S. Cl. CPC G06F 12/0223; G06F 2212/1024; G06F 2212/2022

(57) ABSTRACT

A storage device comprises a storage controller, and a nonvolatile memory device comprising a plurality of pages corresponding to a plurality of consecutive physical addresses. The plurality of pages include a plurality of valid pages storing a plurality of valid data and a plurality of empty pages. Logical addresses of valid data stored in valid pages corresponding to consecutive physical addresses among the plurality of valid pages is consecutive, and logical addresses of valid data stored in valid pages corresponding to discontinuous physical addresses due to the plurality of empty pages among the plurality of valid pages is discontinuous.

### CROSS-REFERENCE TO RELATED APPLICATION

This application claims priority to and the benefit of Korean Patent Application No. 10-2025-0003091 filed with the Korean Patent Office on Jan. 8, 2025 and Korean Patent Application No. 10-2025-0041631 filed with the Korean Patent Office on Mar. 31, 2025, the entire contents of each of which are incorporated herein by reference.

### BACKGROUND

Storage devices such as solid state drives (SSDs) may store mapping information between logical page addresses and physical page addresses of data as a mapping table. When a storage device receives a data processing request and the logical page address of the data from a host device, it may use a mapping table to obtain the physical page address of the corresponding data.

SSDs may not overwrite data. Therefore, when SSDs receive a request to update data from the host device, SSDs may program new data into a new page and invalidate the existing data. That is, since the physical page addresses of data change dynamically, SSDs may need to update the mapping table periodically or in real time.

As the capacity of SSDs increases, the size of the mapping table that stores mapping information between logical page addresses and physical page addresses may also increase. Therefore, if SSDs read the mapping table for each request from the host device, it may result in significant processing delays.

### SUMMARY

Some implementations relate to a storage device that performs reordering of logical page address (LPAs).

Some implementations relate to a storage device that reduces the time consumed in processing a request from a host device. A storage device according to the present disclosure, comprises: a storage controller, and a nonvolatile memory device comprising a plurality of valid pages and a plurality of empty pages, wherein the plurality of valid pages include: first valid pages corresponding to consecutive physical addresses and configured to store first valid data, the first valid data having consecutive logical addresses, and second valid pages corresponding to discontinuous physical addresses based on at least one of the plurality of empty pages, the second valid pages being configured to store second valid data having discontinuous logical addresses.

A storage device of the present disclosure, comprises: a nonvolatile memory device comprising: a first memory block configured to include a plurality of valid data and a plurality of invalid data, and a second memory block configured to include a plurality of pages corresponding to a plurality of consecutive physical addresses, and a storage controller configured to, based on a maintenance operation of the first memory block, obtain a plurality of logical addresses of the plurality of valid data and perform a reordering process, and wherein the reordering process comprises programming a plurality of first valid data to the plurality of pages, wherein the plurality of first valid data is included in a predetermined range of the plurality of valid data and corresponds to a plurality of consecutive first logical addresses.

A nonvolatile memory device of the present disclosure, comprises: a first valid page corresponding to a first physical address and configured to store first data corresponding to a first logical address, a second valid page corresponding to a second physical address consecutive in ascending order from the first physical address and configured to store second data corresponding to a second logical address in ascending order from the first logical address, a first empty page corresponding to a third physical address consecutive in ascending order from the second physical address, and a third valid page corresponding to a fourth physical address consecutive in ascending order from the third physical address and being spaced apart by a first offset from the second physical address, the third valid page being configured to store third data corresponding to a third logical address spaced apart by a second offset from the second logical address, and wherein the second offset is a same as the first offset.

### BRIEF DESCRIPTION OF THE DRAWINGS

FIG. 1 is a diagram illustrating a storage system according to some implementations.

FIG. 2 is a block diagram of a storage device according to some implementations.

FIG. 3 is a diagram illustrating an example of a memory cell array according to some implementations.

FIG. 4 is a diagram illustrating data stored in a nonvolatile memory device according to some implementations.

FIG. 5 is a diagram illustrating a source block according to some implementations.

FIG. 6 is a diagram for explaining an operation method of a page alignment unit according to some implementations.

FIG. 7 is a diagram illustrating a memory region within a buffer memory according to some implementations.

FIG. 8 is a drawing for explaining an operation method of a page alignment unit according to some implementations.

FIG. 9 is a region mapping table according to some implementations.

FIG. 10 is a flowchart of an operation method of a storage controller according to some implementations.

FIG. 11 is a diagram illustrating a memory block according to some implementations.

FIG. 12 is an exemplary address mapping table.

FIG. 13 is a diagram for explaining an operation method of a page alignment unit according to some implementations.

### DETAILED DESCRIPTION

Below, with base to the attached drawings, some implementations of the present disclosure are described in detail so that a person having ordinary skill in the art to which the present disclosure pertains may easily practice it. However, the present disclosure may be implemented in various different forms and is not limited to the implementations described herein.

And in order to clearly explain the present disclosure in the drawings, parts unrelated to the explanation are omitted, and similar parts are given similar drawing base numerals throughout the specification. In the flowchart described with base to the drawings, the order of operations may be changed, several operations may be merged, some operations may be split, and certain operations may not be performed.

Additionally, expressions written in the singular may be interpreted as singular or plural, unless explicit expressions such as “one” or “singular” are used. Terms that include ordinal numbers, such as first, second, etc., may be used to describe various components, but the components are not limited by these terms. These terms may be used to distinguish one component from another.

The terms “unit” and the like described in the specification may mean a unit capable of processing at least one function or operation described in the specification, and this may be implemented by hardware or a circuit, software, or a combination of hardware or a circuit and software.

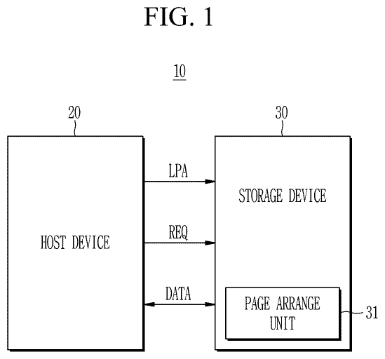

FIG. 1 is a diagram illustrating a storage system according to some implementations.

In some implementations, the storage system 10 may be included in user devices such as a personal computer, a laptop computer, a server, a media player, a digital camera, or an automotive device such as a navigation system, a black box, or an automotive electrical device. Alternatively, the storage system 10 may be included in a mobile system such as a mobile phone, a smart phone, a tablet personal computer, a wearable device, a healthcare device, or an Internet of Things IoT device.

As illustrated in FIG. 1, the storage system 10 may include a host device 20 and a storage device 30.

The host device 20 may control the overall operation of the storage system 10.

The host device 20 may communicate with the storage device 30 through various interfaces. For example, the host device 20 may communicate with the storage device 30 through various interfaces such as USB (Universal Serial Bus), MMC (MultiMediaCard), PCI-E (PCIExpress), ATA (AT Attachment), SATA (Serial AT Attachment), PATA (Parallel AT Attachment), SCSI (Small Computer System Interface), SAS (Serial Attached SCSI), ESDI (Enhanced Small Disk Interface), IDE (Integrated Drive Electronics), NVMe (Non-Volatile Memory Express), etc.

The host device 20 may provide a logical page address LPA and a request signal REQ to the storage device 30. Additionally, the host device 20 may exchange data DATA with the storage device 30.

The storage device 30 may be accessed by the host device 20. For example, the storage device 30 may be implemented in the form of SSD (a solid state drive), a smart SSD, eMMC (an embedded MultiMedia Card), UFS (an embedded Universal Flash Storage) memory device, a UFS memory card, CF (a Compact Flash), SD (a Secure Digital), a Micro-SD (Micro Secure Digital), a Mini-SD (Mini Secure Digital), an xD (extreme Digital), a Memory Stick, or a similar form.

In some implementations, the storage device 30 may store data DATA or process data DATA in response to a request signal REQ of the host device 20. For example, in response to a request signal REQ from the host device 20, the storage device 30 may read data stored in a physical page (hereinafter, referred to as a page) corresponding to a logical page address LPA within the storage device 30, or program data into a page corresponding to a logical page address LPA within the storage device 30. The storage device 30 may store mapping information between a logical page address LPA and a physical page address, for example, as an address mapping table. Accordingly, the storage device 30 may identify a physical page address corresponding to a logical page address LPA within the storage device 30 based on the address mapping table in response to a request signal REQ of the host device 20. The storage device 30 may read data stored in a page corresponding to a logical page address LPA or program data in a page corresponding to a logical page address LPA based on an address mapping table in response to a request signal REQ of the host device 20.

In some implementations, the storage device 30 may perform various maintenance operations to efficiently manage data stored within the storage device 30. For example, if a read operation on specific data stored in a storage device 30 is repeated, surrounding data may be affected. To prevent this, the storage device 30 may perform read reclaim, which moves data stored in a memory block to another memory block before a read operation for specific data is repeated a predetermined number of times. Alternatively, since the storage device 30 is not capable of overwriting, when it receives a request from the host device 20 to update already written data with new data, the storage device 30 may write new data to a new page. At this time, pages that the data was previously written may become invalid. In order to efficiently manage data stored in the storage device 30, the storage device 30 may perform garbage collection to move valid data of a memory block in the storage device 30 to a new memory block and erase the existing memory block to reuse the existing memory block. Hereinafter, the memory block where data was previously written is referred to as the source block, and the memory block where data will be written is referred to as the target block. Here, the target block may mean a memory block where data has not yet been written.

As described above, the physical page address of data stored in the storage device 30 may change due to read reclaim or garbage collection, etc., which involve an operation of moving data of a source block in the storage device 30 to a target block. Accordingly, the storage device 30 may update the address mapping table that stores mapping information between logical page addresses and physical page addresses. Additionally, the storage device 30 may read the address mapping table for each operation of the storage device 30 according to a read request from the host device 20. However, since the address mapping table is very large in size, there is a problem that the performance of the storage device 30 deteriorates when the address mapping table is read for each operation of the storage device 30 according to a read request from the host device 20.

In some implementations, the storage device 30 may include a page alignment unit 31. When data stored in a source block is moved to a target block, the page alignment unit 31 may perform a re-alignment process for the moved data. Specifically, when data stored in a source block moves to a target block, the logical page addresses of data stored in pages corresponding to consecutive physical page addresses within the target block may have continuity by the reordering process of the page alignment unit 31. For example, logical page addresses of data stored in pages corresponding to consecutive physical page addresses in ascending order within a target block may be consecutive in ascending order. In some implementations, when data stored in a source block moves to a target block, the target block may include empty pages due to the reordering process of the page alignment unit 31. Empty pages within a target block may be located between valid pages that store data.

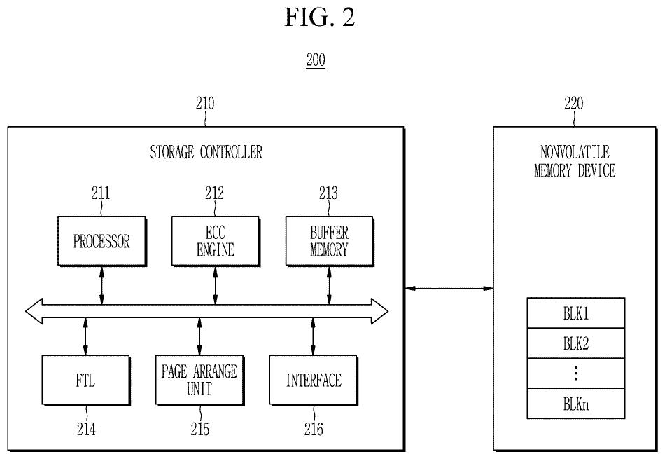

In some implementations, when the storage device 30 receives a data read request from the host device 20, the page alignment unit 31 may determine an LPA offset based on the logical page address of the corresponding data. The page alignment unit 31 may determine the physical page address of the corresponding data by adding the LPA offset to the physical page base address. Therefore, the storage device 30 according to some implementations may obtain a physical page address of data based on a logical page address without reading an address mapping table. This has the advantage of improving the performance of the storage device 30. A specific description of the operation method of the page alignment unit 31 and the data alignment method of the storage device 30 will be described later with base to FIG. 2 to FIG. 13.

FIG. 2 is a block diagram of a storage device according to some implementations.

In some implementations, the storage device 200 may include a storage controller 210 and a non-volatile memory device 220.

The storage controller 210 may control the overall operation of the storage device 200.

In some implementations, the storage controller 210 may include a processor 211, an error correction code (ECC) engine 212, a buffer memory 213, a flash translation layer (FTL) 214, a page alignment unit 215, and an interface 216.

In some implementations, the processor 211 may control the overall operation of the storage device 200 or the storage controller 200. The processor 211 may control the operation of the storage controller 210 to program data requested from the host device 20 (of FIG. 1) into the nonvolatile memory device 220.

In some implementations, the ECC engine 212 may perform error correction operations. The ECC engine 212 may perform ECC encoding on data to be programmed into a nonvolatile memory device 220 and may perform ECC decoding on data read from the nonvolatile memory device 220.

In some implementations, in a program operation that programs data requested from a host device 20 into a nonvolatile memory device 220, the ECC engine 212 may perform ECC encoding on the data to generate parity. Therefore, encoded data generated by the ECC engine 212 performing ECC encoding may include data received from the host device 20 and parity. In some implementations, the parity may include information about the logical page address LPA of data received from the host device 20. The ECC engine 212 may perform ECC encoding on data to generate parity including information on a logical page address LPA, and generate encoded data including data received from the host device 20 and parity.

In some implementations, the FTL 214 may include firmware or software that manages data program, data read, and block erase operations of the nonvolatile memory device 220. The firmware of FTL 214 may be executed by the processor 211.

In some implementations, the FTL 214 may translate a logical page address LPA of a host device 20 into a physical page address used to actually store data within a non-volatile memory device 220. Specifically, the FTL 214 may use an address mapping table to convert a logical page address LPA of a host device 20 into a physical page address of a nonvolatile memory device 220.

In some implementations, the page alignment unit 215 may perform a re-alignment process on data stored in a source block within the non-volatile memory device 220 during various maintenance operations, such as read reclaim or garbage collection. The page alignment unit 215 may detect a logical page address of encoded data stored in a nonvolatile memory device 220 from the parity of the corresponding data and store the data in a page within a target block. At this time, the logical page addresses of data stored in pages corresponding to consecutive physical page addresses within the target block may have continuity. The logical page addresses of data stored in pages corresponding to consecutive in ascending order physical page addresses within a target block may be consecutive in ascending order.

In some implementations, the page alignment unit 215 may temporarily store data in the buffer memory 213 while performing a re-alignment process on data stored in a source block within the non-volatile memory device 220. The page alignment unit 215 may align data in the buffer memory 213 according to the order of logical page addresses. Buffer memory 213 may include valid space where valid data is stored and empty space where no data is stored.

In some implementations, the buffer memory 213 may be a dynamic random access memory DRAM or a static random access memory SRAM. In some implementations, the buffer memory 213 may be located inside the page alignment unit 215.

In some implementations, the interface 216 may include a host interface and a memory interface. The storage device 200 may communicate with the host device 20 via a host interface within the interface 216. The storage device 200 may receive data from the host device 20 or provide data to the host device 20 via the host interface.

The storage device 200 may communicate with a nonvolatile memory device 220 via a memory interface. The storage device 200 may provide commands, addresses, and data, etc. to the nonvolatile memory device 220 through the memory interface. The storage device 200 may receive data stored in a nonvolatile memory device 220 through a memory interface.

A nonvolatile memory device 220 may store data. The nonvolatile memory device 220 may operate in response to the control of the storage controller 210. A nonvolatile memory device 220 may include a plurality of memory blocks BLK1 to BLKn that store data. Each of the plurality of memory blocks BLK1 to BLKn may include the plurality of memory cells. A nonvolatile memory device 220 may include a memory cell array. The memory cell array may be divided into the plurality of memory blocks BLK1 to BLKn. A memory cell array may include the plurality of wordlines. A plurality of memory cells may be connected to each word line. Each memory cell may be, for example, a NAND memory cell. In some implementations, a predetermined number of memory cells connected to a word line may form a page, and the plurality of pages may form a block.

In some implementations, a plurality of memory blocks BLK1, to BLKn may include source blocks and target blocks. In some implementations, a target block within a plurality of memory blocks BLK1, to BLKn may include valid pages where valid data is stored and empty pages where no data is stored. The logical page addresses of data stored in valid pages corresponding to consecutive physical page addresses may increase sequentially. The logical page addresses of data stored in valid pages corresponding to consecutive physical page addresses may be consecutive in ascending order. The logical page addresses of data stored in valid pages corresponding to consecutive physical page addresses may sequentially increase in correspondence to the physical page addresses.

In some implementations, the offset between the physical page addresses of any two valid pages within a target block and the offset between the logical page addresses of data stored in the two valid pages may be the same. For example, for first data stored in a first valid page and second data stored in a second valid page, an offset between the physical page address of the first valid page and the physical page address of the second valid page may be the same as an offset between the first logical page address of the first data and the second logical page address of the second data. In some implementations, the target block may include empty pages that do not store data, and the empty pages within the target block may be located between valid pages that store valid data. In some implementations, the target block may include empty pages in which no data is stored, and the physical page address of the empty pages within the target block may be a value between the physical page addresses of valid pages in which valid data is stored.

In some implementations, logical addresses of valid data stored in valid pages corresponding to a plurality of consecutive physical addresses among a plurality of valid pages within a target block may be consecutive, and logical addresses of valid data stored in valid pages corresponding to a plurality of physical addresses that are discontinuous due to a plurality of empty pages among the plurality of valid pages may be discontinuous. Specifically, the logical addresses of valid data stored in valid pages corresponding to a plurality of physical addresses that are consecutive in ascending order among a plurality of valid pages within a target block may be consecutive in ascending order, and the logical addresses of the valid data may be discontinuous due to a plurality of empty pages among the plurality of valid pages.

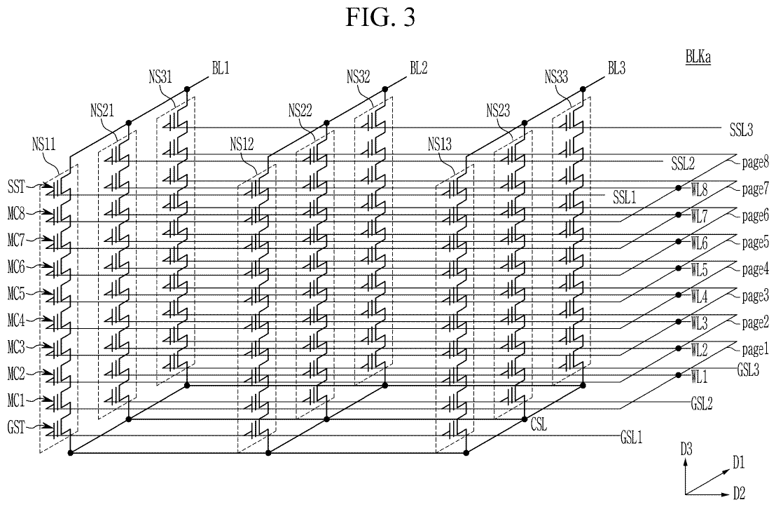

FIG. 3 is a diagram illustrating an example of a memory cell array according to some implementations.

The memory cell array illustrated in FIG. 3 is a memory cell array having a vertical structure, and may be, for example, a NAND flash memory cell array. The memory cell array illustrated in FIG. 3 may correspond to one block BLKa or a part of the block BLKa among a plurality of memory blocks BLK1 to BLKn included in the memory cell array.

In some implementations, a memory block BLKa may include a plurality of memory NAND strings NS11 to NS33 connected between a plurality of bit lines BL1 to BL3 extending in a first direction D1 and a common source line CSL. A plurality of memory NAND strings NS11 to NS33 may be formed in a third direction D3 perpendicular to the first direction D1. Each of the plurality of memory NAND strings NS11 to NS33 may include a string select transistor SST, a plurality of memory cells MC1 to MC8, and a ground select transistor GST.

The gate of the string select transistor SST may be connected to the corresponding string select line SSL1 to SSL3. The plurality of memory cells MC1 to MC8 may each be connected to a corresponding word line WL1 to WL8. Word lines WL1 to WL8 may correspond to gate lines. The gate of the ground select transistor GST may be connected to the corresponding ground select line GSL1 to GSL3. The string select transistor SST may be connected to the corresponding bit line BL1 to BL3, and the ground select transistor GST may be connected to the common source line CSL.

Among the memory cells MC1 to MC8 of each of the plurality of memory NAND strings NS11 to NS33, memory cells located at the same height may share the same word line WL. For example, the first memory cell MC1 of each of the plurality of memory NAND strings NS11 to NS33 may share the first word line WL1. The second memory cell MC2 of each of the plurality of memory NAND strings NS11 to NS33 may share a second word line WL2. Similarly, the third to eighth memory cells MC3 to MC8 of each of the plurality of memory NAND strings NS11 to NS33 may share the third to eighth word lines WL3 to WL8.

Memory cells sharing the same wordline may form a physical page page1 to page8. For example, a fourth page page4 may include memory cells arranged in an area where one wordline WL4 and the plurality of bit lines BL1 to BL3 intersect. A memory having a structure like that of FIG. 3 may erase operation in block units and program operations in page units corresponding to each word line WL1 to WL8.

In some implementations, each page page1 to page8 may have a corresponding physical page address. Within each memory block, physical page addresses may increase sequentially. For example, the physical page address of the first page page1 may be ‘PPA1’, the physical page address of the second page page2 may be ‘PPA2’, and the physical page address of the third page page3 may be ‘PPA3’. Here, it is explained that the physical page address increases in the order of the page location, but it is not limited to this. Among the physical page addresses within each memory block, the physical page address with the smallest value (e.g., PPA1) may be referred to as the physical page base address. A memory block BLKa according to some implementations may include a plurality of pages in which physical page addresses sequentially increase by the number of pages in the memory block BLKa from a physical page base address. A memory block BLKa according to some implementations may include a plurality of pages in which physical page addresses are consecutive in ascending order from a physical page base address equal to the number of pages in the memory block BLKa.

A plurality of memory cells may be stacked in a third direction D3 that is perpendicular to the plane formed by the first direction D1 and the second direction D2. The plurality of memory cells may be arranged in three-dimensionally different planes or layers. For example, memory cells connected to a wordline may be located in the same layer. That is, the number of word lines and the number of layers may be the same. However, it is not limited to this. For example, a single layer may contain the plurality of wordlines.

The memory block BLKa illustrated in FIG. 3 is exemplary, and the number of memory NAND strings NS, the number of cell transistors (GST, MC, SST, etc.), and the number of lines (BL, WL, CSL, SSL, GSL, etc.) connected to the cell transistors may be increased or decreased.

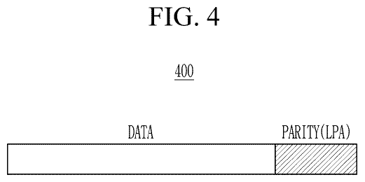

FIG. 4 is a diagram illustrating data stored in a nonvolatile memory device according to some implementations.

As described above in FIG. 2, the storage controller 210 (of FIG. 2) may perform ECC encoding on data received from the host device 20 (of FIG. 1) to generate encoded data 400 including parity. Encoded data 400 may include data DATA received from the host device 20 and parity PARITY. In some implementations, parity PARITY may include information about the logical page address LPA of data received from the host device 20.

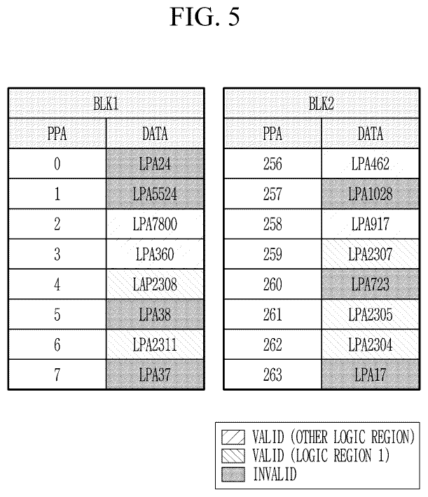

In some implementations, the page alignment unit 215 (of FIG. 2) may identify a logical page address of valid data stored in a source block during a maintenance operation of the storage device 200. Specifically, the page alignment unit 215 may identify a logical page address of valid data based on the parity of valid data stored in a source block during a maintenance operation of the storage device 200. The page alignment unit 215 may divide the source block into the plurality of logical regions to rearrange valid data stored in the source block. A detailed explanation of this will be provided later with base to FIG. 5.

FIG. 5 is a diagram illustrating a source block according to some implementations.

In some implementations, a source block may store the plurality of data. Referring to FIG. 5, the plurality of source blocks BLK1, BLK2 may store data DATA in a page corresponding to a physical page address PPA. For convenience of explanation, an exemplary logical page address LPA of the corresponding data is displayed in the DATA item in FIG. 5. The page alignment unit 215 may obtain a logical page address LPA of data based on the parity of data stored in the source block.

A plurality of source blocks BLK1, BLK2 may contain the plurality of valid data VALID and the plurality of invalid data INVALID. During a maintenance operation process of a storage device 200, a plurality of valid data of a plurality of source blocks BLK1, BLK2 are moved to a target block, and a plurality of invalid data are erased.

In some implementations, the plurality of source blocks BLK1, BLK2 may include the plurality of logical regions. Each of the plurality of logical regions may store the plurality of data corresponding to the plurality of logical page addresses. The size of each logical region (logic region size, LRS) may be determined in advance. Additionally, each logical region may have its own unique logical region number LRN. Therefore, the logical page base address of each logical region may be determined in advance. Here, the logical page base address of each logical region may refer to the logical page address with the smallest address value among the logical page addresses of data stored in each logical area. The logical page base address of each logical region may be determined by the product of the size of each logical region LRS and the logical region number LRN. For example, in the case of a region where the size of each logical region LRS is determined as ‘256’ and the logical region number LRN is ‘9’, the logical page base address of the logical region may be determined as ‘LPA2304’.

According to some implementations, the logical page addresses in each logical region may sequentially increase from a logical page base address. Based on the logical page base address of each logical region and the size of each logical region LRS, the plurality of logical page addresses of the plurality of data stored within each logical region may be determined in advance. For example, in the case of a region where the size of each logical region LRS is determined as ‘256’ and the logical region number LRN is ‘9’, the logical page address of the data stored in the corresponding logical region may be determined as ‘LPA2304’ to ‘LPA2559’.

Referring to FIG. 5, the plurality of source blocks BLK1, BLK2 may include the plurality of logical regions. For example, the plurality of source blocks BLK1, BLK2 may include a first logical region LOGIC REGION 1 containing data corresponding to logical page addresses (e.g., LPA2304, LPA2305, . . . ) and another logical region (OTHER LOGIC REGION). Logical page addresses of data included in other logical regions (OTHER LOGIC REGION) (e.g., LPA7800, LPA360, . . . ) may be included in the same or different logical regions.

In some implementations, the page alignment unit 215 may calculate the number of valid pages in each logical region. The page alignment unit 215 may determine a logical region with the largest number of valid pages among the plurality of logical regions as a reordering region. Specifically, the page alignment unit 215 may determine a logical region with the largest number of valid pages among a plurality of logical regions as a reordering region, and may align logical page addresses of the reordering region in the target block in ascending order. Alternatively, the page alignment unit 215 may determine a logical region where the number of valid pages exceeds a predetermined reference value as a reordering region. In the following, it is assumed that the page alignment unit 215 has determined the first logical region LOGIC REGION 1 as the reordering region.

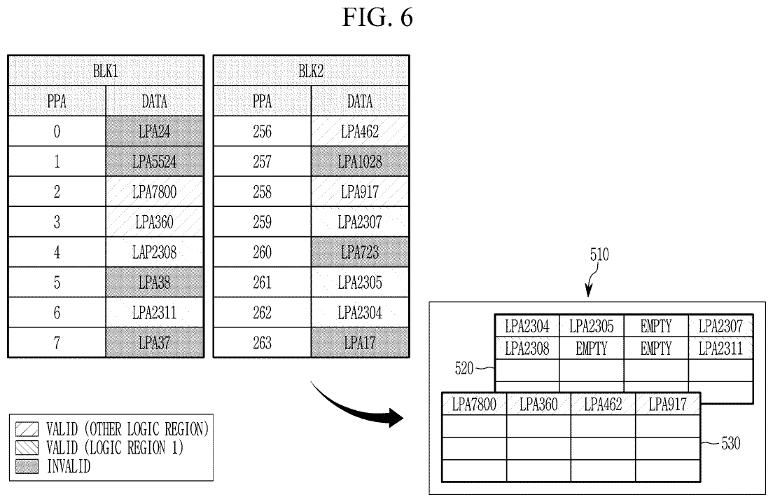

FIG. 6 is a drawing for explaining an operation method of a page alignment unit according to some implementations.

In some implementations, valid data moving from a source block to a target block may be temporarily stored in a buffer memory 510. Referring to FIG. 6, the page alignment unit 215 may temporarily store valid data within the source blocks BLK1, BLK2 in the plurality of memory regions 520, 530 of the buffer memory 510.

In some implementations, the buffer memory 510 may include the plurality of memory regions 520, 530. Data within a logical region determined as a reordering region among valid data within a source block BLK1, BLK2 may be stored in the same memory region within a buffer memory 510. For example, data within the first logical region LOGIC REGION 1 determined as a reordering region among the valid data within the source block BLK1, BLK2 may be stored in the first memory region 520 within the buffer memory 510. Data within other logical regions (OTHER LOGIC REGION) among valid data within the source block BLK1, BLK2 may be stored in a second memory region 530 within the buffer memory 510.

In some implementations, the plurality of memory regions 520, 530 within the buffer memory 510 may include the plurality of spaces. The size of each space may be equal to the size of a page in the memory block. The page alignment unit 215 may store data in each space within a plurality of memory regions 520, 530. In some implementations, the page alignment unit 215 may store each of data within the first logical region LOGIC REGION 1 in each space within the first memory region 520, and store each of data within the other logical region (OTHER LOGIC REGION) in each space within the second memory region 530.

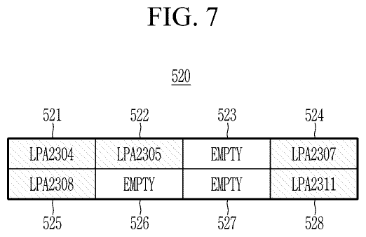

FIG. 7 is a diagram illustrating a memory region within a buffer memory according to some implementations. For convenience of explanation, only some of the spaces in the first memory region 520 are shown here.

In some implementations, the first memory region 520 may include a plurality of spaces 521, 522, . . . , 528. The page alignment unit 215 may store data in each space within the first memory region 520. The page alignment unit 215 may store data within the first logical region LOGIC REGION 1 determined as the reordering region in each space within the first memory region 520. The page alignment unit 215 may store data within the first logical region LOGIC REGION 1 determined as the reordering region in each space within the first memory region 520 in ascending order of logical page addresses.

In some implementations, the page alignment unit 215 may determine a space in which data corresponding to a logical page base address LPA2304 of a first logical region LOGIC REGION 1 in the first memory region 520 is to be stored. The page alignment unit 215 may determine the first space 521 in the first memory region 520 as a space where data corresponding to the logical page base address LPA2304 of the first logical region LOGIC REGION 1 is stored. Hereinafter, the space in the memory region where data corresponding to the logical page base address is stored is referred to as the base space. In some implementations, the page alignment unit 215 may store data corresponding to a logical page base address LPA2304 in the base space 521. In some implementations, the page alignment unit 215 may obtain the address of the base space 521.

In some implementations, the page alignment unit 215 may determine the LPA offset based on the logical page address of each data. The LPA offset may refer to a distance from a base space 521 within the first memory area 520. The page alignment unit 215 determines the LPA offset of each data and may store data corresponding to a space spaced apart from the base space 521 by the LPA offset.

In some implementations, the page alignment unit 215 may calculate a unique logical region number LRN of the logical region storing the data, based on the logical page address of each data, prior to determining the LPA offset. The page alignment unit 215 may use equation 1 to calculate a unique logical region number LRN of the logical region storing the corresponding data. For example, if the logical page address LPA of data is ‘2305’ and the size of the logical region LRS is ‘256’, the logical region number LRN of the logical region storing the data corresponding to the logical page address LPA2305 may be determined as ‘9’.

$$LRN = Quotient ( \frac{LPA}{LRS} ) \qquad Equation 1$$

In some implementations, the page alignment unit 215 may determine the LPA offset. The page alignment unit (215) may calculate the LPA offset offset_{LPA} of the corresponding data using equation 2. For example, if the logical page address LPA is ‘2305’, the logical region size LRS is ‘256’, and the logical region number LRN is ‘9’, the LPA offset offset_{LPA} of the corresponding data may be determined as ‘1’.

$${offset}_{LPA} = LPA - LRN \times LRS \qquad Equation 2$$

In some implementations, the page alignment unit 215 may store data corresponding to a space spaced apart from the base space 521 in the first memory area 520 by an LPA offset. Referring to FIG. 7, the page alignment unit 215 may obtain the address of the base space 521 where the logical page base address LPA2304 of the first memory area (520) is stored. The page alignment unit 215 may determine the LPA offset of data to be stored thereafter and store the corresponding data in a space spaced apart from the base space 521 by the LPA offset. For example, the page alignment unit 215 may store data corresponding to a logical page address LPA2305 in a space 522 spaced apart by ‘1’ from the base space 521. In this way, the page alignment unit 215 may rearrange data in ascending order of logical page addresses in each space within the first memory region 520.

However, there may be no data corresponding to some logical page addresses in the source block. For example, the storage device 200 may not have received data corresponding to some logical page addresses from the host device 20, or the data corresponding to some logical page addresses may be erased data as invalid data. In this case, the page alignment unit 215 may reserve space in the first memory region 520 corresponding to the logical page address. Referring to FIG. 7, data corresponding to empty spaces 523, 526, 527 may be data that has never been received from the host device 20 or may be data erased as invalid data.

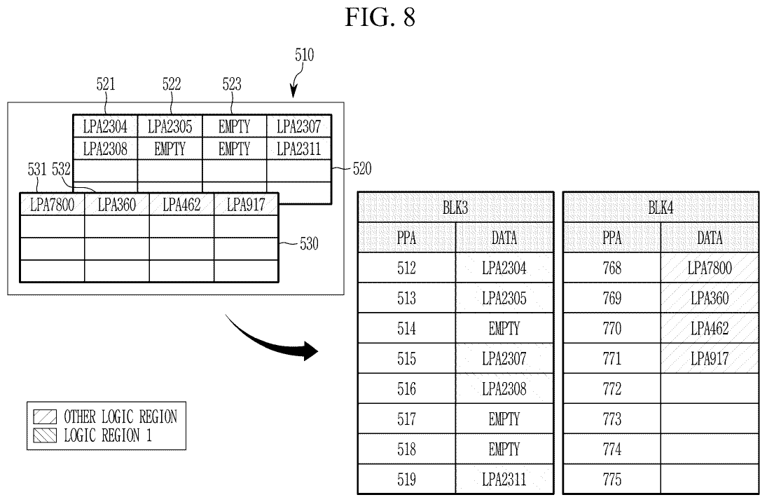

FIG. 8 is a drawing for explaining an operation method of a page alignment unit according to some implementations.

In some implementations, the page alignment unit 215 may move data temporarily stored in the buffer memory to the target block. The page alignment unit 215 may program data temporarily stored in the buffer memory into a target block. Referring to FIG. 8, the page alignment unit 215 may program data temporarily stored in the buffer memory 510 into a plurality of target blocks BLK3, BLK4 in which data is not stored.

In some implementations, the page alignment unit 215 may correspond the space of each memory region 520, 530 of the buffer memory 510 to pages of a plurality of target blocks BLK3, BLK4. Specifically, the page alignment unit 215 may correspond each memory region 520, 530 to each target block BLK3, BLK4, and correspond the space of each memory region 520, 530 to each page of each target block BLK3, BLK4.

In some implementations, the page alignment unit 215 may sequentially correspond the space of each memory region 520, 530 of the buffer memory 510 to the pages of each target block BLK3, BLK4. Specifically, the page alignment unit 215 may correspond the space of each memory region 520, 530 of the buffer memory 510 in ascending order of the physical page address starting from the page corresponding to the physical page base address of each target block BLK3, BLK4. For example, the page alignment unit 215 may correspond the first memory region 520 to the target block BLK3, correspond the first space 521 of the first memory region 520 to the first page PPA512 of the target block BLK3, correspond the second space 522 of the first memory region 520 to the second page PPA513 of the target block BLK3, and correspond the third space 523 of the first memory region 520 to the third page PPA514 of the target block BLK3.

In some implementations, the page alignment unit 215 may program data stored in the space of each memory region 520, 530 of the buffer memory 510 into the corresponding page of the target block BLK3, BLK4. The page alignment unit 215 may program data stored in the space of each memory region 520, 530 of the buffer memory 510 in ascending order of the physical page address starting from the page corresponding to the physical page base address. For example, the page alignment unit 215 may program data stored in the first space 521 of the first memory region 520 to the first page PPA512 of the target block BLK3, and may program data stored in the second space 522 of the first memory region 520 to the second page PPA513 of the target block BLK3.

In some implementations, the plurality of memory regions 520, 530 of the buffer memory 510 may include a plurality of empty spaces. When the page alignment unit 215 programs data stored in the plurality of spaces of the plurality of memory regions 520, 530 of the buffer memory 510 into each page of the target block BLK3, BLK4, no data may be stored in a page within the target block corresponding to an empty space of the buffer memory 510. For example, the page alignment unit 215 may maintain a page PPA514 in the block BLK3 corresponding to the third space 523 of the first memory region 520 as an empty page.

In some implementations, in a target block containing reordered data, logical page addresses of data stored in valid pages corresponding to consecutive physical page addresses may increase sequentially. In a target block containing rearranged data, logical page addresses of data stored in valid pages corresponding to consecutive physical page addresses may be consecutive in ascending order. Referring to FIG. 8, in the target block BLK3, logical page addresses (e.g., LPA2304, LPA2305) of data stored in valid pages corresponding to consecutive physical page addresses (e.g., PPA512, PPA513) may be consecutive in ascending order. Additionally, in the target block BLK3, logical page addresses (e.g., LPA2307, 2308) of data stored in valid pages corresponding to consecutive physical page addresses (e.g., PPA515, PPA516) may be consecutive in ascending order.

In some implementations, in a target block containing reordered data, the offset between the physical page addresses of any two valid pages within the target block and the offset between the logical page addresses of data stored in the two valid pages may be the same. Referring to FIG. 8, in the target block BLK3, the offset ‘3’ between the physical page addresses (e.g., PPA512, PPA515) of any two valid pages may be the same as the offset ‘3’ between the logical page addresses (e.g., LPA2304, LPS2307) of data stored in the two valid pages.

In some implementations, the target block BLK3 may include empty pages in which no data is stored, and the empty pages within the target block BLK3 may be located between valid pages in which valid data is stored. In some implementations, the value of the physical page address PPA514 of an empty page where no data is stored may be a value between the physical page addresses PPA513, PPA515 of a valid page where valid data is stored. In some implementations, in a target block containing reordered data, logical page addresses of data stored in valid pages corresponding to consecutive physical page addresses may be discontinuous in empty pages.

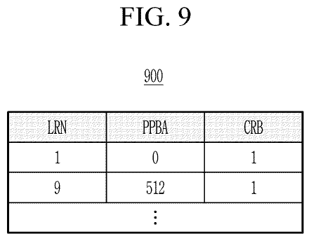

In some implementations, the page alignment unit 215 may store information of the reordering region in a region mapping table RMT. A detailed description of the region mapping table is provided below with reference to FIG. 9.

FIG. 9 is a region mapping table according to some implementations.

In some implementations, the page alignment unit 215 may generate a region mapping table 900 while performing the reordering process. The area mapping table 900 may store various information about logical regions. For example, the page alignment unit 215 may store a region mapping table including information about the logical region number LRN of the reordering region, the physical page base address PPBA, and the continuity of the logical region CRB in the buffer memory 213 (of FIG. 2). Here, the continuity of the logical region CRB may indicate whether the logical region has been selected as a reordering region and has been reordered to the target block.

When a storage device 200 (of FIG. 2) according to some implementations receives a read request from a host device 20 (of FIG. 1) together with a logical page address of data, a storage controller 210 (of FIG. 2) may determine whether to calculate an LPA offset corresponding to the logical page address or read an address mapping table based on the region mapping table 900.

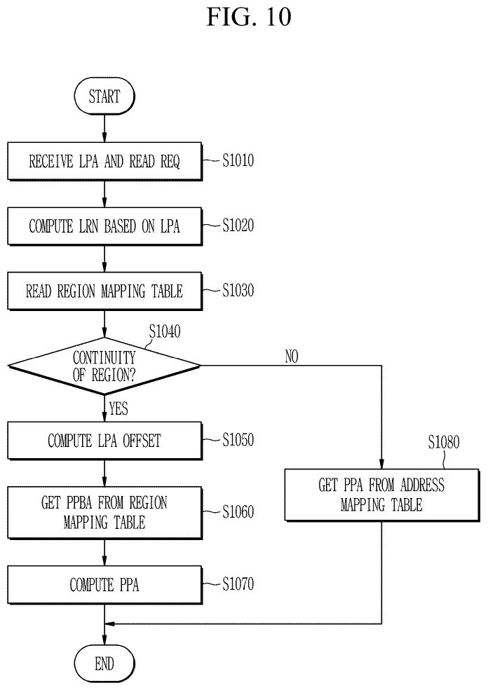

FIG. 10 is a flowchart of an operation method of a storage controller according to some implementations.

In some implementations, the storage controller may receive a read request READ REQ along with a logical page address LPA of data from a host device S1010.

In some implementations, the storage controller may calculate a logical region number LRN of a logical region containing the logical page address LPA from the logical page address LPA S1020. The storage controller may use the Equation 1 to calculate the logical region number LRN of the logical region containing the logical page address LPA.

In some implementations, the storage controller may read the area mapping table 900 (of FIG. 9) S1030. The storage controller may search for the logical region number LRN of the logical region including the corresponding logical page address LPA from the region mapping table 900 and determine the continuity of the corresponding logical region CRB S1040. The storage controller may search for the logical region number LRN of the logical region including the corresponding logical page address LPA from the region mapping table 900 and determine whether the corresponding logical region has been selected as a reordering region and reordered to the target block.

In some implementations, the storage controller may calculate the LPA offset offset_{LPA} if it determines that the logical region is contiguous S1050. In some implementations, the storage controller may compute the LPA offset offset_{LPA} when it determines that the logical region is reordered to the target block. The storage controller may use the Equation 2 to calculate the LPA offset offset_{LPA} of the data corresponding to the logical page address LPA.

In some implementations, the storage controller may obtain a physical page base address PPBA of the corresponding logical region from the region mapping table 900 S1060. The storage controller may obtain a physical page base address PPBA corresponding to the logical region number LRN of the logical region from the region mapping table 900.

In an implementation, the storage controller may calculate a physical page address PPA of the data S1070. The storage controller may use the Equation 3 to calculate the physical page address PPA of the data. The storage controller may determine the physical page address PPA of the corresponding data by adding the LPA offset offset_{LPA} to the physical page base address PPBA.

$$PPA = PPBA + {offset}_{LPA} \qquad Equation 3$$

In some implementations, if the storage controller determines that the corresponding logical area is not contiguous, it may obtain the physical page address PPA of the corresponding data using the address mapping table S1080. In some implementations, if the storage controller determines that the logical region is not reordered to the target block, it may use the address mapping table to obtain the physical page address PPA of the data.

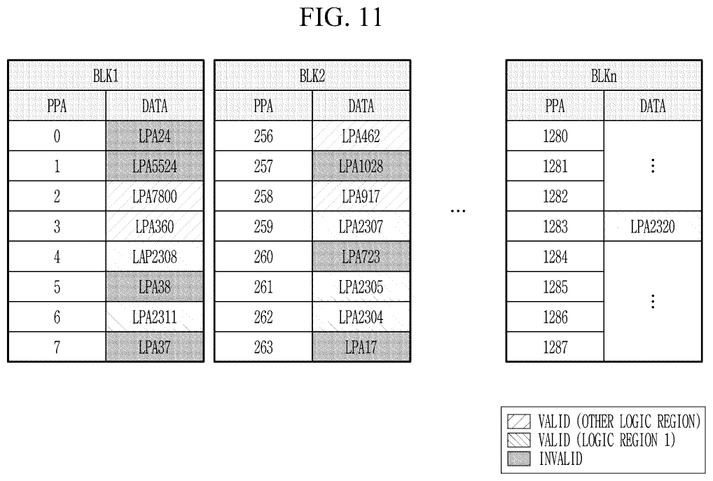

FIG. 11 is a diagram illustrating a memory block according to some implementations.

In some implementations, data in a logical region determined as a reordering region in a source block may be reordered in a target block. The logical page address of a logical region determined as a reordering region in a source block may have continuity in the target block.

In some implementations, some data within a logical region determined as a reordering region in the source block may not be included in the source block. For example, some data within a logical region may be stored in a source block BLK1, BLK2, and some data within a logical region may be stored in another memory block BLKn. However, in order for the logical page address of the logical region determined as the reordering region to have continuity in the target block, all data within the logical region stored in the storage device may be aligned to the target block.

Referring to FIG. 11, the page alignment unit 215 may determine the first logical region LOGIC REGION 1 as a reordering region based on the number of valid pages of the first logical region LOGIC REGION 1 in the source block BLK1, BLK2. When the size of the logical region LRS is ‘256’ and the logical region number LRN of the first logical region LOGIC REGION 1 is ‘9’, the logical page address of the first logical region LOGIC REGION 1 may be determined from ‘LPA2304’ to ‘LPA2559’. However, some data of the first logical region LOGIC REGION 1 (e.g., data corresponding to ‘LPA2320’) may be stored in a memory block BLKn other than the source block BLK1, BLK2.

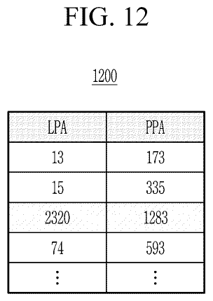

FIG. 12 is an exemplary address mapping table.

In some implementations, the page alignment unit 215 may read the address mapping table 1200 during the process of performing the reordering process. The address mapping table 1200 may store the logical page address of data for which the storage device 200 receives a program request from the host device 20 and the corresponding physical page address. The page alignment unit 215 may determine a reordering region and may read the address mapping table 1200 during the process of performing the reordering process. The page alignment unit (215) may determine whether a logical page address of a logical region determined as a reordering region has received a program request from the host device 20 by reading the address mapping table 1200.

Referring to FIG. 11, the page alignment unit 215 may determine the first logical region LOGIC REGION 1 as a reordering region based on the number of valid pages of the first logical region LOGIC REGION 1 in the source block BLK1, BLK2. The logical page address of the first logical region LOGIC REGION 1 may be determined from ‘LPA2304’ to ‘LPA2559’. A page alignment unit 215 according to some implementations may read an address mapping table 1200 and determine a logical page address LPA2320 among logical page addresses of a first logical region LOGIC REGION 1 that is not stored in a source block BLK1, BLK2. According to some implementations, the page alignment unit 215 may obtain a physical page address PPA1283 of data corresponding to a logical page address LPA2320 from the address mapping table 1200.

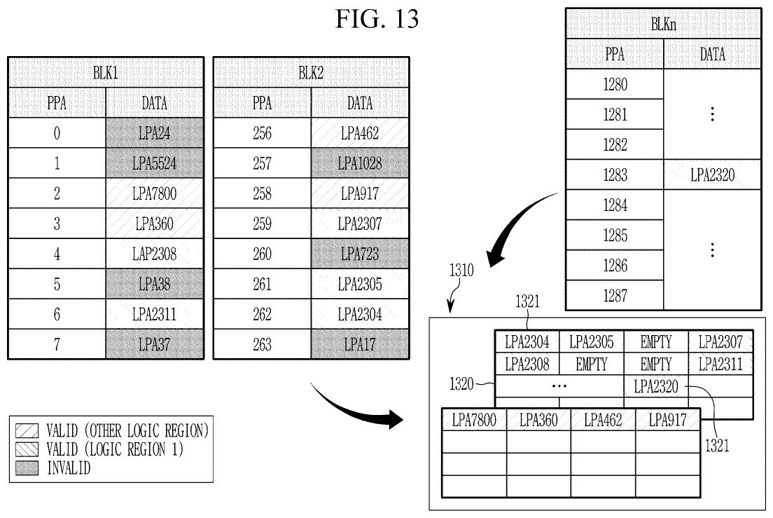

FIG. 13 is a drawing for explaining an operation method of a page alignment unit according to some implementations.

A page alignment unit 215 according to some implementations may read an address mapping table and determine a logical page address LPA2320 among logical page addresses of a first logical region LOGIC REGION 1 that is not stored in a source block BLK1, BLK2. A page alignment unit 215 according to some implementations may read an address mapping table and obtain a physical page address PPA1283 of data corresponding to a logical page address LPA2320. In some implementations, when the page alignment unit 215 stores data corresponding to a logical page address of a first logical region LOGIC REGION 1 within a source block BLK1, BLK2 in the memory region 1320 of the buffer memory 1310, the page alignment unit 215 may store data corresponding to a logical page address LPA2320 stored in the memory block BLKn in the memory region 1320. The page alignment unit 215 determines the logical area number LRN and LPA offset of the logical page address LPA2320, and may store data corresponding to the logical page address LPA2320 in a space 1322 spaced apart from the base space 1321 of the memory region 1320 by the LPA offset.

In some implementations, the page alignment unit 215 may move data temporarily stored in the memory region 1320 to the target block, and the logical page address of the first logical region LOGIC REGION 1 may have continuity in the target block.

While the present disclosure contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

Although the implementations of the present disclosure have been described in detail above, the scope of the present disclosure is not limited thereto, and various modifications and improvements made by those skilled in the art using the basic concept of the present disclosure defined in the following claims also fall within the scope of the present disclosure.

What is claimed is:

1. A storage device, comprising:
a storage controller, and
a nonvolatile memory device comprising a plurality of valid pages and a plurality of empty pages,
wherein the plurality of valid pages include:
first valid pages corresponding to consecutive physical addresses and configured to store first valid data, the first valid data having consecutive logical addresses, and
second valid pages corresponding to discontinuous physical addresses based on at least one of the plurality of empty pages, the second valid pages being configured to store second valid data having discontinuous logical addresses.

2. The storage device of claim 1,
wherein the first valid pages and the second valid pages of the plurality of valid pages include a third valid page and a fourth valid page,
wherein an offset between a first physical address of the third valid page and a second physical address of the fourth valid page is a same as an offset between a first logical address of third valid data stored in the third valid page and a second logical address of fourth valid data stored in the fourth valid page.

3. The storage device of claim 2, wherein:
a third physical address of a first empty page among the plurality of empty pages has a value between the first physical address and the second physical address.

4. The storage device of claim 3, wherein:
the first physical address, the third physical address, and the second physical address are consecutive, and the first logical address and the second logical address are discontinuous.

5. The storage device of claim 2, wherein the nonvolatile memory device comprises:
a first memory block configured to store the plurality of valid data and a plurality of invalid data, wherein the first memory block is configured to be erased by the storage controller, and
a second memory block comprising the plurality of valid pages and the plurality of empty pages,
a third logical address of first invalid data among the plurality of invalid data has a value between the first logical address and the second logical address.

6. The storage device of claim 5, wherein:
the first logical address, the third logical address, and the second logical address are consecutive.

7. The storage device of claim 5, wherein:
the storage controller is configured to move the plurality of valid data stored in the first memory block to the second memory block based on a maintenance operation for the first memory block.

8. The storage device of claim 7, wherein
the maintenance operation is a read reclaim or a garbage collection.

9. A storage device comprising:
a nonvolatile memory device comprising:
a first memory block configured to include a plurality of valid data and a plurality of invalid data, and
a second memory block configured to include a plurality of pages corresponding to a plurality of consecutive physical addresses, and
a storage controller configured to, based on a maintenance operation of the first memory block, obtain a plurality of logical addresses of the plurality of valid data and perform a reordering process, and
wherein the reordering process comprises programming a plurality of first valid data to the plurality of pages, wherein the plurality of first valid data is included in a predetermined range of the plurality of valid data and corresponds to a plurality of consecutive first logical addresses.

10. The storage device of claim 9, wherein:
the storage controller is configured to, based on a program request received from the host device, perform error correction code encoding for data received from the host device, and generate encoded data including the data and parity, and
wherein the parity includes a logical address corresponding to the data.

11. The storage device of claim 10, wherein:
the storage controller is configured to obtain the plurality of logical addresses from parity of the plurality of valid data.

12. The storage device of claim 9,
wherein the plurality of pages include a plurality of valid pages and a plurality of empty pages,
wherein the plurality of valid pages include pages corresponding to a plurality of consecutive physical addresses, and
wherein the reordering process causes logical addresses of the plurality of first valid data programmed in the pages to be consecutive, and causes logical addresses of the plurality of first valid data in the plurality of empty pages to be discontinuous.

13. The storage device of claim 9, wherein the storage controller is configured to:
calculate a logical page address (LPA) offset corresponding to a second logical address based on a read request and the second logical address received from a host device,
determine a physical address of data corresponding to the second logical address based on the LPA offset, and
output the data stored in the physical address to the host device.

14. The storage device of claim 13, wherein:
the first memory block is configured to include a plurality of logical regions comprising a plurality of data,
the plurality of logical regions include a first logical region having the plurality of first valid data, and
the predetermined range is determined based on a size of the first logical region.

15. The storage device of claim 14, wherein:
the first logical region stores bigger valid data than valid data stored in the remaining logical regions of the plurality of logical regions.

16. The storage device of claim 14, wherein:
the storage controller is configured to determine a logical region number of the first logical region based on the size of the first logical region and the plurality of consecutive first logical addresses, and determine the LPA offset based on the size of the first logical region and the logical region number of the first logical region.

17. The storage device of claim 13, wherein:
a physical address of data corresponding to the second logical address is a sum of the LPA offset and a smallest physical address among the plurality of the consecutive physical addresses.

18. The storage device of claim 9, wherein:
the maintenance operation is a read reclaim or a garbage collection.

19. A nonvolatile memory device, comprising:
a first valid page corresponding to a first physical address and configured to store first data corresponding to a first logical address,
a second valid page corresponding to a second physical address consecutive in ascending order from the first physical address and configured to store second data corresponding to a second logical address in ascending order from the first logical address,
a first empty page corresponding to a third physical address consecutive in ascending order from the second physical address, and
a third valid page corresponding to a fourth physical address consecutive in ascending order from the third physical address and being spaced apart by a first offset from the second physical address, the third valid page being configured to store third data corresponding to a third logical address spaced apart by a second offset from the second logical address, and
wherein the second offset is a same as the first offset.

20. The nonvolatile memory device of claim 19, comprising:
a fourth valid page corresponding to a fifth physical address and configured to store fourth data corresponding to a fourth logical address, and
the fifth physical address is consecutive in ascending order from the fourth physical address, and the fourth logical address is consecutive in ascending order from the third logical address.
